(19) United States
(12) Patent Application Publication
(10) Pub. No.: US 2020/0409333 A1
(43) Pub. Date: Dec. 31, 2020

(54) Method for operating an extrusion system and extrusion system

(71) Applicant: KRAUSSMAFFEI EXTRUSION GMBH, Hannover (DE)

(72) Inventor: Harald Hepke, Hannover (DE)

(21) Appl. No.: 16/959,211

(22) PCT Filed: Dec. 18, 2018
(86) PCT No.: PCT/EP2018/085436

§ 371 Date: Jun. 30, 2020

(30) Foreign Application Priority Data
Jan. 10, 2018 (DE) 10 2018 100 455.9

(51) Int. Cl. G05B 19/4065; B30B 11/24; B29C 48/92; B29C 48/49; B29C 48/33

(52) U.S. Cl. CPC G05B 19/4065; B30B 11/241; B29C 48/33; B29C 48/49; B29C 48/92

(57) ABSTRACT

A method for operating an extrusion system with the automatically executed steps of detecting, on a time-dependent basis, at least two operating parameters, which are selected from the following list: a screw rotational speed parameter, from which the number of rotations made by an endless screw of an extruder of the extrusion system as of a predefined point in time can be determined, and/or a torque characteristic value, which describes the torque applied to the endless screw, and/or an operating pressure in a cylinder of the extruder and/or an abrasion parameter, which describes an abrasiveness of material processed in the extruder, calculating, from the operating parameters, a wear parameter, more particularly a time for maintenance, which encodes a wear state of at least one component of the extruder, and outputting a maintenance message, which encodes the wear parameter.

The invention relates to a method for operating an extrusion system. According to a second aspect, the invention relates to an extrusion system with (a) a first extruder for delivering a first rubber component (b) a second extruder for delivering a second rubber component and (c) a machine control for actuating the extruders.

Extrusion systems are used for example for the production of treads for vehicle tyres. Depending on the structure of the tread, three, four or five and sometimes more than five, extruders are used, which respectively produce a rubber mixture. All the rubber mixtures are connected jointly to the tread and are thereafter further processed to form a tyre.

Extrusion systems must be maintained at regular time intervals, because they are subject to wear. In this respect, it is known to use operating hours counters. The time after which a component of an extrusion system has to undergo maintenance is established by means of empirical values. When the maintenance interval is selected to be too great, losses of quality can occur in the manufactured product. When the maintenance interval is selected to be too short, an unnecessary effort with unnecessary costs arises. It is therefore desirable to know the optimum time for maintenance as accurately as possible.

The invention is based on the problem of reducing disadvantages in the prior art. The invention solves the problem through a method for operating an extrusion system with the automatically executed steps (a) time-dependent detecting of at least two operating parameters, which are selected from the following list: (i) a screw rotational speed parameter, from which the number of rotations is able to be determined which an endless screw of an extruder of the extrusion system has carried out as of a predefined point in time, (ii) a torque characteristic value, which describes the torque applied to the endless screw, (iii) an operating pressure in a cylinder of the extruder (iv) an abrasion parameter which describes an abrasiveness of material processed in the extruder, (b) calculating from the operating parameters a wear parameter, in particular a time for maintenance, which encodes a wear state of at least one component of the extruder, and (c) outputting a maintenance message, which encodes the wear parameter.

It is advantageous in the invention that the time for maintenance can be determined better. As losses of quality are not to be tolerated in extruders, hitherto the maintenance interval was selected so that an excessive wear was ruled out with a very high degree of certainty. However, this leads to the time for maintenance generally being too soon. Through the fact that in the method according to the invention the at least two operating parameters are detected, the time for maintenance at which at least one component of the extrusion system must undergo maintenance, can be established more precisely. This reduces the maintenance effort.

In addition, it is advantageous in the invention that this advantage is able to be achieved with few means. Thus, generally it is sufficient to provide the machine control with a corresponding software. In so far as is necessary, an additional memory can be incorporated into the machine control.

It is advantageous, in addition, that through the method according to the invention time paths of the operating parameters are obtained, which can be linked with the data which are obtained on exchanging of components of the extrusion system, for example an endless screw. Thus, wear which is determined on the exchanged component can be correlated with the measured paths of the operating parameters. In this way, it can be established more precisely than hitherto when the corresponding component has to undergo maintenance. In other words, the time-dependent detecting of the operating parameters leads to the time for maintenance being able to be established with ever greater accuracy.

Within the scope of the present description, time-dependent detection is understood to mean that data for the respective operating parameter are detected at regular intervals and are preferably stored. In particular, the operating parameters are detected at least once every 10 seconds, preferably at least once per second. It is possible, but not necessary, that the respective operating parameters are measured directly. In particular, it is possible that machine parameters or other measured values are received, which give a clear indication of the respective operating parameter.

The screw rotational speed parameter is understood to mean either the number of rotations which the endless screw of the extruder has carried out as of a predefined point in time, or else a parameter from which this number of rotations is able to be determined. For example, the screw rotational speed parameter can be the path which a point, preferably on the outer circumference of the endless screw, has covered since the predefined point in time.

The torque characteristic value is understood to mean in particular the torque itself, alternatively the torque characteristic value is understood to mean a value by means of which the torque characteristic value is able to be determined. For example, the torque characteristic value can be a power consumption of an electric motor which drives the endless screw. Alternatively, the torque characteristic value can be, for example, the armature current of this motor, because the input current is proportional to the torque applied to the endless screw. In addition, it is possible that the torque characteristic value is a monotone function of the actual torque or of one of the above-mentioned parameters. For example, this function can depend over-proportionally on the torque. Thereby, the fact is taken into account that high torques can bring about intensive wear to an above average extent.

The operating pressure is understood in particular to mean the pressure with which an extruder of the extrusion system delivers the extrudate, generally a rubber mixture.

The abrasion parameter is understood to mean in particular a value which describes by how much greater the abrasive effect of the respective processed rubber mixture is relative to a reference rubber mixture. For example, when the extruder wears twice as intensively in the case of a predefined rubber mixture relative to the reference rubber mixture, then this abrasion parameter is equal to 2. This therefore concerns a relative value. Pure rubber, for example, can be used as reference rubber mixture. The abrasion parameter can also describe, for example, the corrosivity of the rubber mixture.

The wear parameter can be a number, a quantity or a vector. Other data formats are also possible. In particular, it is possible that the wear parameter is a multi-dimensional quantity. The wear parameter is understood to mean in particular the time for maintenance, therefore the point in time at which at least one component of the extruder is to be exchanged, in order to ensure that the extrusion system provides the required quality.

The outputting of a maintenance message is understood to mean in particular that a signal, perceptible or not perceptible by a person, is emitted, which encodes the wear parameter, in particular the time for maintenance. Alternatively, it is possible for example that the wear percentage indicates in percentages the extent to which the maximum permissible wear has already been reached.

According to a preferred embodiment, the method is carried out on an extrusion system which has at least three extruders. The method then comprises in particular the above-mentioned steps (a) time-dependent determining of a throughput parameter, which encodes the specific throughput of one of the extruders, wherein this determining of the throughput parameter is preferably carried out for all extruders, and (b) outputting of a maintenance message, when the throughput parameter for at least one of the extruders falls below a predefined throughput parameter.

The specific throughput indicates how much extrudate the respective extruder delivers. When the respective extruder is worn too intensively, the corresponding specific throughput drops below the predefined throughput parameter threshold. The specific throughput is determined in particular by (i) measuring the length-specific weight of a multi-component rubber profile produced by the extrusion system, in particular a tread, (ii) measuring the speed of the rubber profile and (iii) calculating the specific throughput of each extruder by multiplying length-specific weight, speed and surface portion, which the cross-section of the rubber profile which the respective extruder injects, has on the overall cross-section of the rubber profile.

The throughput parameter can be the specific throughput itself or a quantity derived therefrom. For example, the throughput parameter can be the specific energy, i.e. the driving energy of the respective extruder, which is necessary for producing a predefined mass of extrudate. In addition, it is possible that the throughput parameter is a monotone function of the specific throughput, which depends over-proportionally or under-proportionally on the specific throughput.

According to a preferred embodiment, the time-dependent detecting of the operating parameter comprises in addition (a) a detecting of a vibration parameter, which describes an intensity of a vibration of at least one component of the extrusion system, and/or (b) a detecting of a temperature, in particular of a bearing of a motor of the extrusion system, and/or (c) a compiling of operating hours during which the extrusion system was in operation. A vibration which lies above a predefined threshold value indicates that too intensive wear is present. When the temperature on a bearing of the motor exceeds a temperature threshold, this is an indication that the bearing is faulty and should be exchanged. Preferably, the maintenance message encodes at least one of these said operating parameters.

Preferably, the reckoning of the wear parameter comprises a calculating of a pressure load in the form of the sum of a function of the operating pressure depending on the operating time, in particular the sum of the operating pressure over the operating time. In other words, the calculating of the wear parameter comprises in particular the calculating of the sum Bₚ=Σ_{t′=0}^{t}ƒ(p(t′). The function f is monotone in p and can be, in particular, the identical function, but preferably Bₚ=Σ_{t′=0}^{t}p(t′). In other words, it is assumed that the wear at a ten times higher pressure is ten times as high. However, it is also possible that the function f depends over-proportionally on the operating pressure p. This takes into account that particularly high pressures contribute over-proportionally to the wear.

Preferably, the time for maintenance is calculated from the earliest point in time at which the pressure load reaches a pressure load threshold or the torque load reaches a torque load threshold. In particular, the time for maintenance is the earliest point in time at which additionally or alternatively the screw rotational speed parameter reaches a screw rotational speed parameter threshold or the operating hours number reaches an operating hours threshold. In other words, the earliest point in time is calculated at which one of the conditions is fulfilled.

Preferably, the method comprises the steps (a) detecting an exchange wear parameter of a component, in particular an endless screw, of an extruder of the extrusion system, (b) exchanging the component for a new component and (c) calculating the time for maintenance for the new component from the exchange wear parameter. It is particularly favourable if in addition the step is carried out that the wear of the new component is detected quantitatively and the calculating of the time for maintenance for the new component is calculated from the exchange wear parameter and the measured wear of the component. During its lifespan, the exchanged component has undergone a load collective, which is characterized by the time profile of the operating parameters.

The invention is explained in further detail below with the aid of the enclosed drawings. There are shown here:

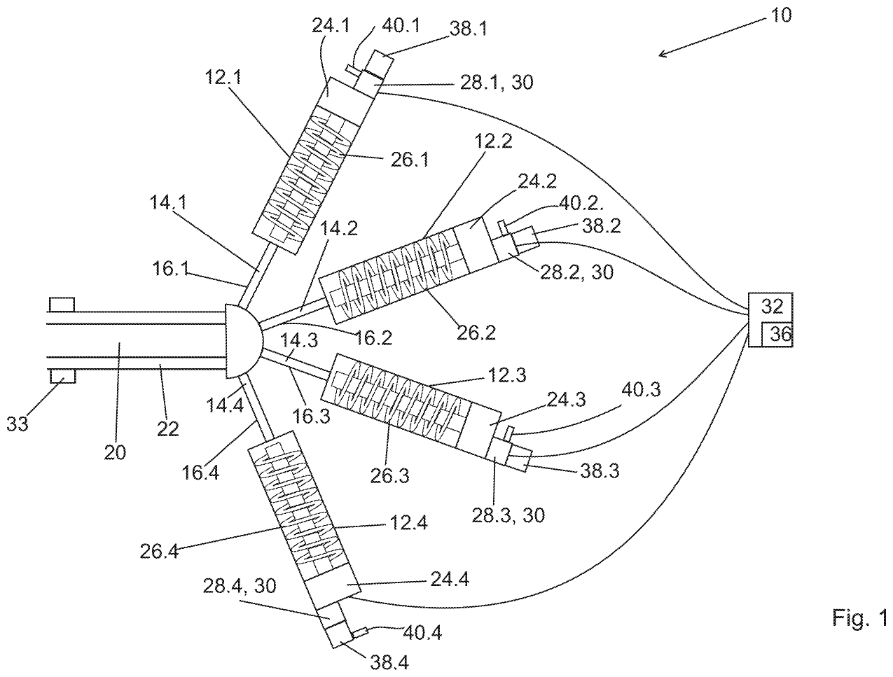

FIG. 1 a diagrammatic view of an extrusion system according to the invention and

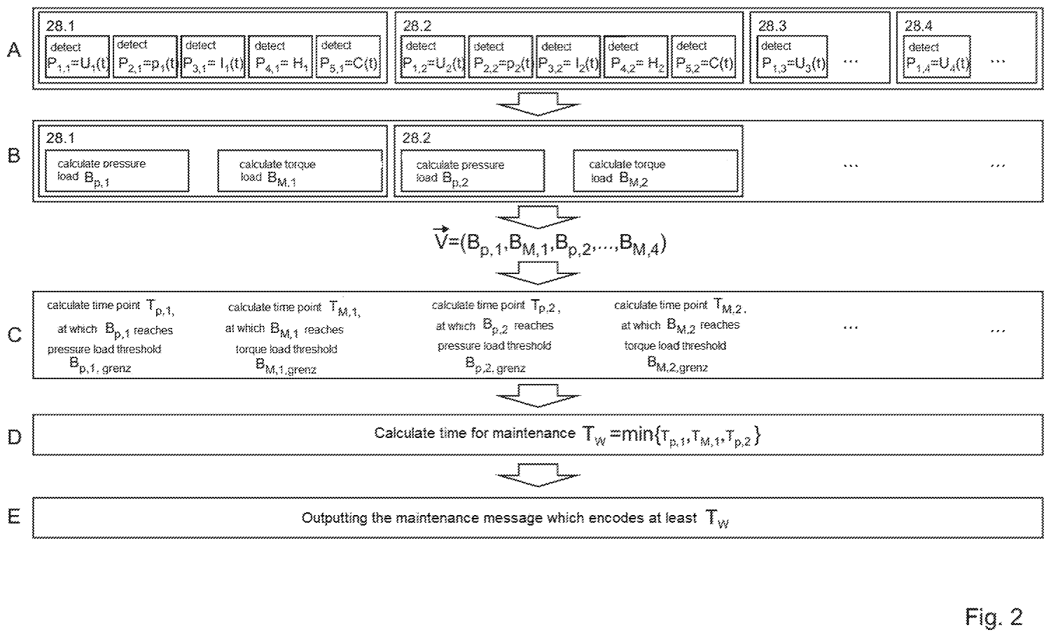

FIG. 2 a flow diagram of a method according to the invention,

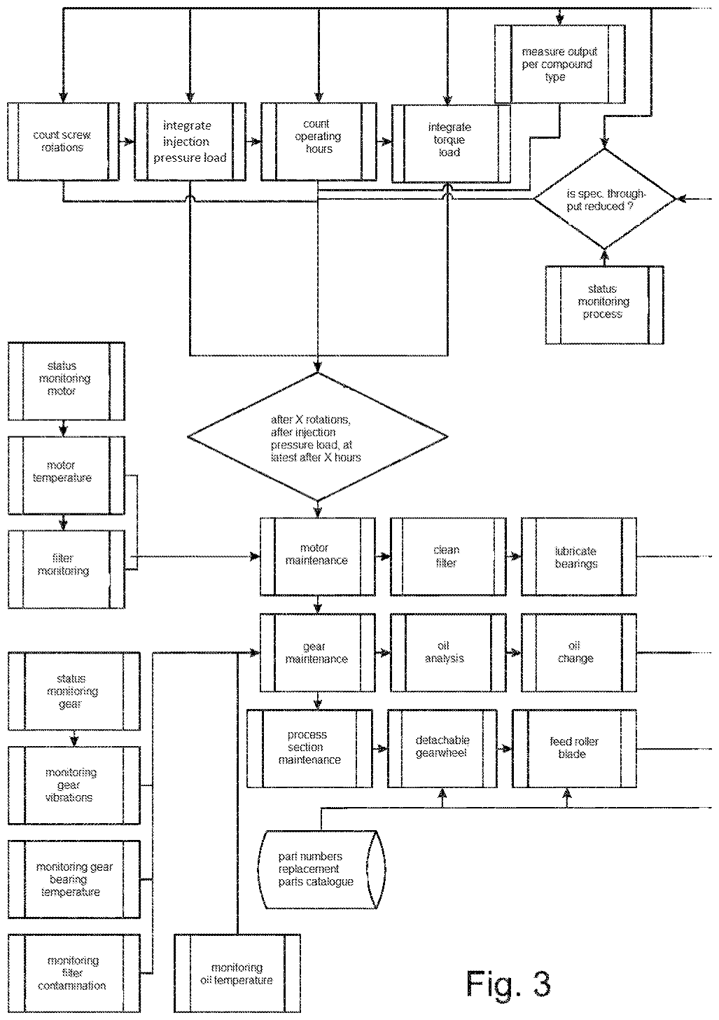

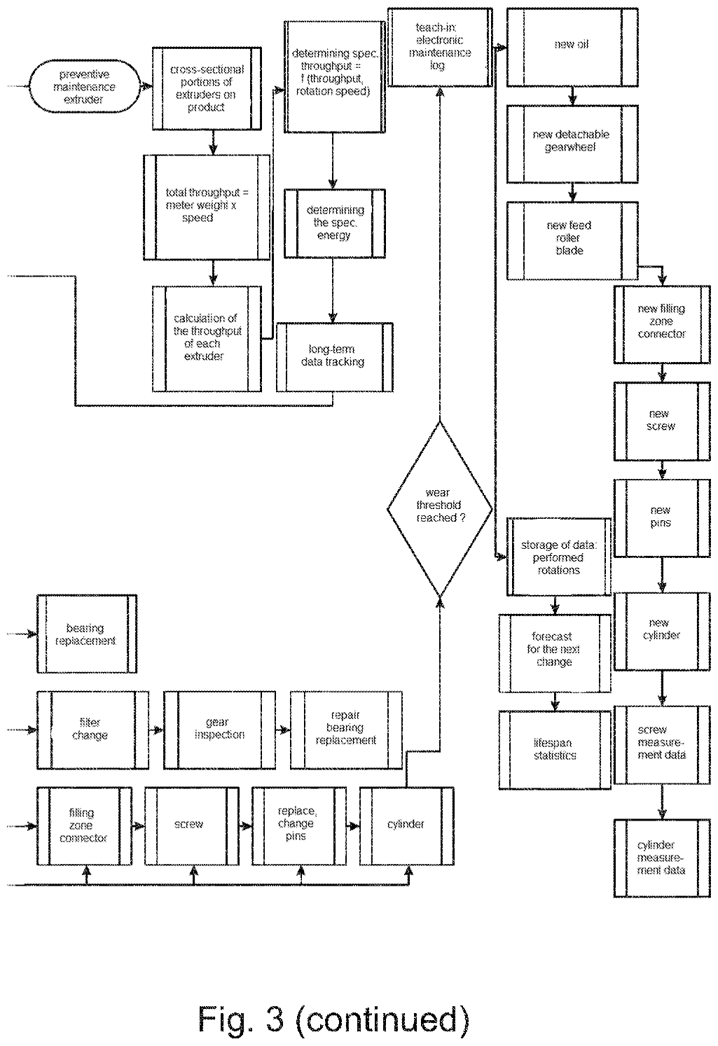

FIG. 3 shows a flow diagram of an alternative method according to the invention.

FIG. 1 shows an extrusion system 10 according to the invention, which has a first extruder 12.1, a second extruder 12.2, a third extruder 12.3 and a fourth extruder 12.4. Each extruder delivers a respective strand 14.i(i=1, . . . , N, wherein N is the number of extruders). These are directed through corresponding pipes 16.i to an extrusion head 18. The extrusion head 18 forms from the strands 14.i a multi-component tread 20, which is deposited onto a conveying device 22.

The extruders 12.i are charged with non-vulcanized rubber material. This material can also be designated as a compound. Each extruder 12.i has an electric motor 24.i, which drives a diagrammatically drawn endless screw 26.i. The motor 26 is actuated by a respective extruder control 28.i. All extruder controls 28.i, . . . , 28.N form jointly a machine control 30. It is possible and preferred that the extruder controls 28 are linked with each other. In addition, it is possible that the machine control 30 has a central control 32, which is connected with the extruder controls 28.i.

On carrying out a method according to the invention, the extruder controls 28.i detect at regular time intervals tᵢ, t₂ . . . operating parameters P_{j,i}(j=1,2, . . . , M, wherein M is the number of the detected operating parameters).

FIG. 2 shows a flow diagram of a method according to the invention. Within the scope of the method according to the invention, regularly for each extruder 12.i a first operating parameter P_{1,i}=Uᵢ in the form of a screw rotational speed parameter of the i^{th} extruder is detected (Step A). This corresponds to the number of the complete rotations of a respective endless screw 26.i after a predefined start point in time tₛ. The screw rotational speed parameter Uᵢ is determined by means of the machine control 30, in particular by the associated extruder control 28.i. Therefore, for the first extruder 12.1 the screw rotational speed parameter U₁(t) is detected, and for the second extruder 12.1 the screw rotational speed parameter U₂(t) is detected, for the third extruder 12.3 U₃(t) and for the fourth extruder 12.4 U₄(t) is detected.

In addition, a second operating parameter P_{2,i}=pᵢ(t) is measured in the form of the operating pressure of the i^{th} extruder. In addition, a third operating parameter P_{3,i}=Iᵢ(t) is detected in the form of the respective armature current which is applied in the motor 24.i. The armature current Iᵢ is a size measurement for the torque Mᵢ which is applied to the endless screw 26.i. In addition, the extruder controls 28.i detect the number of operating hours Hᵢ and the abrasion parameters Cᵢ, which indicate how great the abrasive and/or corrosive effect is described of the compound which is processed at the point in time t in the i^{th} extruder.

In order to make it clear that the respective operating parameters Pⱼ are received from the extruder control 28.1, they bear respectively the index “1.” The further extruder controls 28.2, . . . , 28.N detects preferably the same operating parameters, wherein it is possible that not all extruder controls detect the same operating parameters.

The operating parameter Cᵢ(t) is detected for example in that a corresponding input request is presented on a screen, so that an operator can input this value. The torque characteristic Mᵢ can alternatively be determined in that the torque applied to the endless screw 26.i is detected for example by means of a strain gauge. Again alternatively, instead of the armature current Iᵢ , also the output P_{24.i} of the respective motor 24.i can be detected.

The machine control 30 or the respective extruder control 28.i calculates in a following Step B from the detected operating parameters P_{j,i} a wear parameter \vec{V} which owing to its vector nature could also be designated as wear parameter vector. The pressure loads B_{p,i}, which are calculated according to the formula B_{p,i}=Σ_{t′=0}^{t}ƒ(pᵢ(t′)), are components of the wear parameter \vec{V}. In the present case, the function f is the identical function, which assigns the identical number to each number. In other words, in the present case B_{p,i}=Σ_{t′=0}^{t}pᵢ(t′). The pressure load B_{p,i} describes the contribution which the pressure has on the wear of the i^{th} extruder 12.i. From the sum it becomes evident that for example 10 seconds at a pressure of 200 bar have the same wear effect as 100 seconds at 20 bar.

The machine control 30 or the respective extruder control 28.i calculates from the detected operating parameters P_{j,i} in addition the torque load B_{M,i}, which is calculated according to the formula B_{M,i}=Σ_{t′=0}^{t}g(Mᵢ(t′)). In the present case, the function g is the identical function which assigns the identical number to each number. In other words, in the present case B_{M,i}=Σ_{t′=0}^{t}Mᵢ(t′). The torque load B_{M,i} describes the contribution which the torque M has on the wear of the i^{th} extruder 12.i.

In a subsequent Step C from the pressure load B_{p,i} and the torque load B_{M,i} the respective points in time T_{p,i} and T_{M,i} are calculated, at which a predefined pressure load threshold B_{p,i,grenz} or respectively a predefined torque load threshold B_{M,i,grenz} is reached. This takes place for exmaple by extrapolation of the time profile of the pressure load and torque load. For example, it can be a linear extrapolation. It is to be pointed out that the thresholds can differ from extruder to extruder. This lies for example in that the respective endless screws 26.i can differ from one another with regard to the wear behaviour.

In addition, respectively the points in time are calculated at which the screw rotational speed parameters Uᵢ reaches a respective screw rotational speed parameter threshold U_{i,max}. In addition, it is determined when the operating hours number H reaches an operating hours threshold value Hₘₐₓ. It is to be noted that all these calculations are carried out for all operating parameters and therefore for all extruders. Generally, the thus respectively calculated points in time differ from from another.

In a following Step D, the time for maintenance T_{w} is calculateed as the smallest of these points in time. In Step E a maintenance message is outputted by the machine control 30, if applicable in response to a corresponding enquiry, which message encodes the time for maintenance. For exmaple, the time for maintenance is displayed on a screen of the machine control 30. At the time for maintenance, the extrusion system undergoes maintenance.

The extrusion system 10 comprises a metre weight scale 32, by which the length-specfic weight G of the strand 14 is measured. In addition, the extrusion system 10 has a speed meter 34 for measuring a speed v₁₄ of the strand 14. The machine control 30 is formed for the automatic calculation of the specific throughput from the length-specific weight G, the speed v₁₄ and the respective surface portion A, which the compound has from the extruder 12.i at the finished strand 14. Thus, the specific throughput D_{spez} is calculated and stored in a time-dependent manner. In other words, the specific throughput D_{spez}(t) is determined at regular points in time t and stored in a memory 36 of the machine control 30.

FIG. 1 shows in addition diagrammatically that the extruder 12.i has here a vibration measurement device 38, by means of which a vibration parameter a is detected. In addiiton, the temperature Tᵢ measured respectively by means of thermometers 40.i. In FIG. 1 the thermometers 40.i are drawn in such a way that they measure the temperature of bearings of the electric motors. However, it is particularly favourable if additionally or alternatively the temperature of the bearings of the endless screw is measured. The measurement data are conveyed to the machine control 30. When one of the temperatures T exceeds a predefined temperature threshold or when one of the vibrations exceeds a defined vibration threshold, an alarm is emitted.

By means of the metre weight scale, the length-specific weight G is determined constantly. This takes place as described above. The surface portion of the respective extruder 12.i on the finished tread 20 is determined geometrically and is programed-in in the machine control 30.

FIG. 3 shows a flow diagram of an alternative method according to the invention. At the top left in the flowchart it can be seen that the detecting of the operating parameters P takes place as in the method according to FIG. 2. In addition, it is indicated that after a predefined number of rotations or on reaching a predefined load or a predefined number of drive hours, the indicated maintenance steps are carried out. When in addition the wear threshold is reached, the corresponding component is exchanged.

### LIST OF REFERENCE NUMBERS

10 extrusion system
12 extruder
14 strand
16 pipe
18 extrusion head
20 tread
22 conveying device
24 24 motor
26 endless screw
28 extruder control
30 machine control
33 metre weight scale
34 speed meter
36 memory
38 vibration measuring device
P operating parameter [symbol]
wear parameter
H number of operating hours
C abrasion parameter
I armature current
M torque
i running index i=1, . . . , N
N number of extruders
t time
j running index j=1, . . . , M
M number of operating parameters
U screw rotational speed parameter
tₛ is start point in time
Bₚ pressure load
B_{M} torque load
f function
G vibrate length-specific weight
B_{M,max} torque load threshold
B_{p,max} pressure load threshold
Uₘₐₓ screw rotational speed parameter threshold
Hₘₐₓ operating hours threshold
T_{w} time for maintenance
V₁₄ speed
Aᵢ surface portion
D_{spez} specific throughput
a vibration parameter
T temperature

What is claimed is:

1. A method for operating an extrusion system (10) with the automatically executed steps:
(a) time-dependent detecting of at least two operating parameters (P), which are selected from the following list:
(i) a screw rotational speed parameter (U), from which is able to be determined the number of rotations which an endless sceew (26) of an extruder (12) of the extrusion system (10) has carried out since a predefined point in time, and/or
(ii) a torque characteristic, which describes the torque (M) which is applied to the endless screw (26), and/or
(iii) an operating pressure in a cylinder of the extruder (12) and/or
(iv) an abrasion parameter (C), which describes an abrasivenss of material processed in the extruder (12),
(b) calculating from the operating parameters (P) a wear parameter ( [symbol] ), comprising a time for maintenance (T_{w}), which encodes a wear state at least of one component of the extruder (12), wherein the time for maintenance (T_{w}) is calculated from the earliest point in time at which a threshold (B_{p, max,} B_{M, max,} U_{max,} Hₘₐₓ) corresponding to the operating parameters (P) is reached, and
(c) outputting of a maintenance message, which encodes the wear parameter.

2. The method according to claim 1, characterized wherein the extrusion system (10) has at least three extruders (12.1, 12.2, 12.3) and that the method comprises the following steps:
(a) time-dependent determining of the throughput parameter, whch encodes the specific throughput of an extruder (12) for all extruders (12) and
(b) outputting of the maintenance message when the throughput parameter for at least one extruder (12) falls below a predefined throughput parameter threshold.

3. The method according to claim 1, the time-dependent detecting of the operating parameters (P) comprises in addition
(a) a detecting of a vibration parameter (a), which describes an intensity of a vibration of at least one component of the extrusion system (10), and/or
(b) a detecting of a temperature (T) of a bearing of a motor (24) of the extrusion system (10), and/or
(c) a detecting of operating hours (H), during which the extrusion system (10) was in operation.

4. The method according to claim 1.
(a) the computing of the wear parameter (\vec{V}) comprises
a calculating of a pressure load (Bₚ) in the form of the sum of a function (f) of the operating pressure (p(t)) depending on the operating time (t), comprising the sum (Bₚ=Σ_{t′=0}^{t}ƒ(p(t′))) via the operating pressure (p(t)), and
a calculating of a torque load (B_{M}=Σ_{t′=0}^{t}I(t′)) in the form of the sum of products of a function of the torque characteristic (M(t)) and the operating time (t) comprising the sum via the products of torque characteristic (M(t)) and operating time (t), and
(b) the time for maintenance (T_{W}) from the earliest point in time at which
the pressure load (Bₚ) reaches a pressure load threshold (B_{p,max}) or
the torque load (B_{M}) reaches a torque load threshold (B_{M,max}).

5. The method according to claim 4, wherein the time for maintenance (T_{W}) is calculated from the earliest point in time, at which
the pressure load (Bₚ) reaches the pressure load threshold (B_{p,max}) or
the torque load (B_{M}) reaches the torque load threshold (B_{M,max}) or
the screw rotational speed parameter (U) reaches a screw rotational speed parameter threshold (Uₘₐₓ) or
the operating hours number (H) reaches an operating hours threshold (Hₘₐₓ).

6. An extrusion system (10) with
(a) a first extruder (12.1) for delivering a first rubber component,
(b) at least a second extruder (12.2) for delivering a second rubber component and
(c) a machine control (30) for actuating the extruders (12),
wherein
(d) the machine control (30) is configured for automatically executing a method according to claim 1.
